(19) United States
(12) Patent Application Publication
(10) Pub. No.: US 2013/0174534 A1
(43) Pub. Date: Jul. 11, 2013

(54) SYSTEM AND DEVICE FOR CONTROLLING FLUID FLOW THROUGH A GAS TURBINE EXHAUST

(71) Applicants: Chandrasekhar Pushkaran, Bangalore (IN); Rohit Pruthi, Bangalore (IN); Manjunath Chengappa, Bangalore (IN)

(72) Inventors: Chandrasekhar Pushkaran, Bangalore (IN); Rohit Pruthi, Bangalore (IN); Manjunath Chengappa, Bangalore (IN)

(73) Assignee: GENERAL ELECTRIC COMPANY, Schenectady, NY (US)

(21) Appl. No.: 13/344,422

(22) Filed: Jan. 5, 2012

(51) Int. Cl. F02K 3/02

(52) U.S. Cl. 60/226.3

(57) ABSTRACT

A system and device for controlling fluid flow through a gas turbine exhaust. One gas turbine exhaust may include a strut of the gas turbine exhaust having a first opening configured to permit a fluid to flow between an interior portion of the strut and an exterior portion of the strut. The gas turbine exhaust also may include a moveable plate coupled to the strut and configured to control an amount of the fluid flowing through the first opening.

### BACKGROUND OF THE INVENTION

The subject matter disclosed herein relates generally to turbine engines and, more specifically, to controlling fluid flow through a gas turbine exhaust.

A gas turbine system may include an exhaust diffuser coupled to a gas turbine engine. The gas turbine engine combusts a mixture of fuel and air to generate hot combustion gases, which in turn drive one or more turbines. In particular, the hot combustion gases force turbine blades to rotate, thereby driving a shaft to rotate one or more loads, e.g., electrical generator. The exhaust diffuser receives the exhaust from the turbine, and gradually reduces the pressure and velocity. Within the exhaust diffuser, struts provide structural support but may alter characteristics of the exhaust flow by causing disturbances in the flow. However, the struts may be designed to cause minimal disturbance with the exhaust flow when the turbine engine is operating under full load conditions. Unfortunately, such struts may cause disturbances in exhaust flow when the turbine engine is operating under partial load conditions.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a gas turbine exhaust includes a strut of the gas turbine exhaust having a first opening configured to permit a fluid to flow between an interior portion of the strut and an exterior portion of the strut. The gas turbine exhaust also includes a moveable plate coupled to the strut and configured to control an amount of the fluid flowing through the first opening.

In a second embodiment, a control system to a gas turbine exhaust diffuser includes a controller configured to receive a signal indicating an operational state of a gas turbine engine. The controller is also configured to transmit a control signal to an actuator. The control signal causes the actuator to move a plate coupled to a strut located in the gas turbine exhaust diffuser to alter fluid flow through the strut.

In a third embodiment, a gas turbine exhaust diffuser includes an inner wall forming a hub and an outer wall encompassing the inner wall. The exhaust diffuser also includes a plurality of struts coupled between the inner wall and the outer wall of the gas turbine exhaust diffuser. Each strut includes at least one opening and a movable plate configured to control fluid flow through the at least one opening.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional side view of a gas turbine engine in accordance with an embodiment of the present technique;

FIG. 2 is a perspective view of an embodiment of a gas turbine exhaust diffuser usable with the gas turbine engine of FIG. 1;

FIG. 3 is a cross-sectional view of an embodiment of a strut of the gas turbine exhaust diffuser of FIG. 2 with movable plates;

FIG. 4 is a cross-sectional side view of an embodiment of the strut with movable plates, as illustrated in FIG. 3; and

FIG. 5 is a block diagram of a gas turbine exhaust diffuser system, usable with the gas turbine engine of FIG. 1, having a control system for use in conjunction with movable plates, in accordance with an embodiment of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In a turbine system, struts may be used to provide structural support to the turbine exhaust system. However, in some systems, the struts may cause disturbances in exhaust flow. As discussed below, certain embodiments of a gas turbine exhaust include struts with openings to permit a fluid (e.g., exhaust) to flow from an interior of each strut to an exterior of each strut to decrease exhaust flow disturbances. To control the amount of fluid flowing between the exterior and the interior of the struts, moveable plates may be coupled to the struts and moved between various positions to increase or decrease fluid flow depending on the amount of fluid flow desired to decrease exhaust flow disturbances. For example, the moveable plates may cover openings in the struts to decrease fluid flow through the struts and the moveable plates may uncover openings in the struts to increase fluid flow through the struts. Controlling the fluid flow through the struts may decrease disturbances in the exhaust flowing around the struts (e.g., decrease flow separation).

In one embodiment, the moveable plates may be moved between various positions using an actuation system. The actuation system may move the plates based on the operating load capacity of the gas turbine. For example, the actuation system may move the plates to cover openings in the struts during full operating load capacity (e.g., 100 percent capacity) so that fluid does not flow through the struts (e.g., to have minimal exhaust flow disturbance). Further, the actuation system may move the plates to uncover openings in the struts during less than full operating load capacity (e.g., less than 100 percent capacity) so that fluid flows through the struts (e.g., to alter the exhaust flow to have minimal exhaust flow disturbance).

In another embodiment, the actuation system may move the plates based on sensor measurements and/or a schedule. For example, when sensor measurements pass a certain threshold, the plates may increase or decrease the amount of fluid flowing through the struts. Further, the plates may be moved to different positions based on time periods elapsing. For example, after a first time period elapses the plates may increase fluid flow through the struts and after a second time period elapses the plates may decrease fluid flow through the struts.

Additionally, a controller may be utilized to control the movement of the plates along the struts. For example, the controller may receive signals from one or more sensors that indicate fluid flow parameters or other attributes of the exhaust system. These signals may be utilized by the controller to determine what control signals are to be transmitted to control, for example, the actuation system for moving the plates.

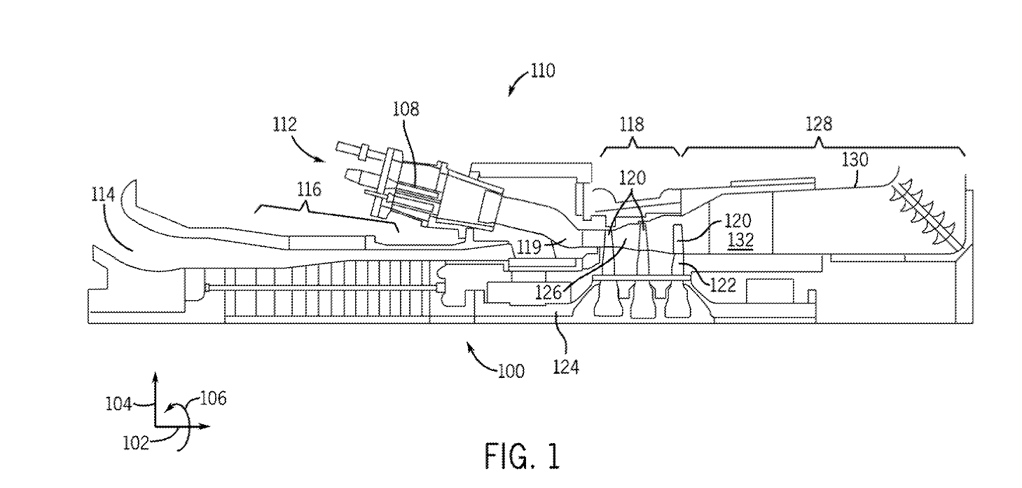

Turning now to the drawings and referring first to FIG. 1, an embodiment of a gas turbine engine 100 is illustrated. The gas turbine engine 100 extends in an axial direction 102. A radial direction 104 illustrates a direction extending outward from the axis of the engine 100. Further, a circumferential direction 106 illustrates the rotational direction around the axis of the engine 100. The gas turbine engine 100 includes one or more fuel nozzles 108 located inside a combustor section 110. In certain embodiments, the gas turbine engine 100 may include multiple combustors 112 disposed in an annular (e.g., circumferential 106) arrangement within the combustor section 110. Further, each combustor 112 may include multiple fuel nozzles 108 attached to or near the head end of each combustor 112 in an annular (e.g., circumferential 106) or other arrangement.

Air enters through an air intake section 114 and is compressed by a compressor 116. The compressed air from the compressor 116 is then directed into the combustor section 110 where the compressed air is mixed with fuel. The mixture of compressed air and fuel is generally burned within the combustor section 110 to generate high-temperature, high-pressure combustion gases, which are used to generate torque within a turbine section 118. As noted above, multiple combustors 112 may be annularly (e.g., circumferentially 106) disposed within the combustor section 110. Each combustor 112 includes a transition piece 119 that directs the hot combustion gases from the combustor 112 to the turbine section 118. In particular, each transition piece 119 generally defines a hot gas path from the combustor 112 to a nozzle assembly of the turbine section 118. As depicted, the turbine section 118 includes multiple blades 120 coupled to a rotor wheel 122 rotatably attached to a shaft 124. The turbine section 118 also includes a nozzle assembly 126 disposed directly upstream of each set of blades 120. The nozzle assemblies 126 direct the hot combustion gases toward the blades 120 where the hot combustion gases apply motive forces to the blades 120 to rotate the blades 120, thereby turning the shaft 124. The blades 120 and shaft 124 rotate in the circumferential direction 106. The hot combustion gases may then exit the gas turbine section 118 into an exhaust diffuser section 128. The exhaust diffuser section 128 reduces the velocity of fluid flow and also increases the static pressure to increase the work produced by the gas turbine engine 100. An outer wall 130 extends axially 102 along the length of the exhaust diffuser section 128. A strut 132 is illustrated abutting the outer wall 130. Further, although only one strut 132 is illustrated in this cross-sectional view, multiple struts 132 are used as support structures between the outer wall 130 and an inner wall (e.g., a hub extending circumferentially 106 at a base of the struts 132) of the exhaust diffuser section 128.

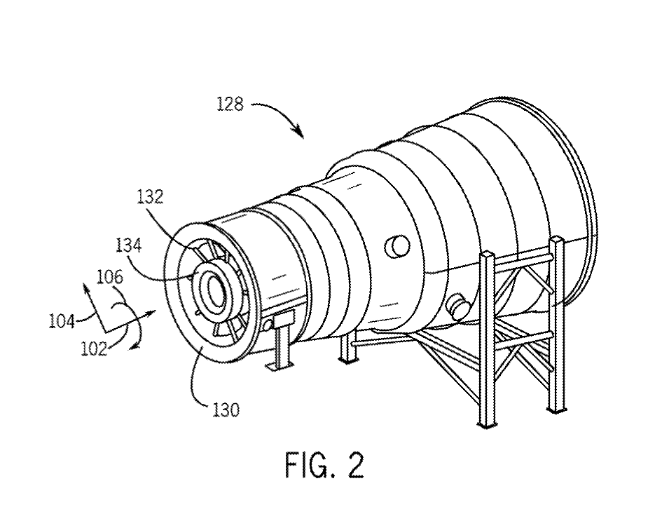

FIG. 2 illustrates a perspective view of an embodiment of a gas turbine exhaust diffuser 128. In particular, the struts 132 are disposed around a hub 134 (e.g., inner wall) and extend radially 104 from the hub 134. The struts 132 are coupled between the hub 134 and the outer wall 130 and thereby structurally support the outer wall 130. As may be appreciated, the outer wall 130 encompasses the hub 134. In certain embodiments, the outer wall 130 may be configured to expand or contract to alter the circumference of the outer wall 130. When turbine exhaust flows into the exhaust diffuser 128, the exhaust flows between the hub 134 and the outer wall 130. Thus, the exhaust flows around the struts 132 and the struts 132 alter the exhaust flow. Therefore, the properties of how the exhaust flows through the exhaust diffuser 128 are affected by the shape and position of the struts 132. For example, in certain struts 132, flow separation may occur at different portions of the struts 132. However, the techniques described below may be used to decrease flow separation.

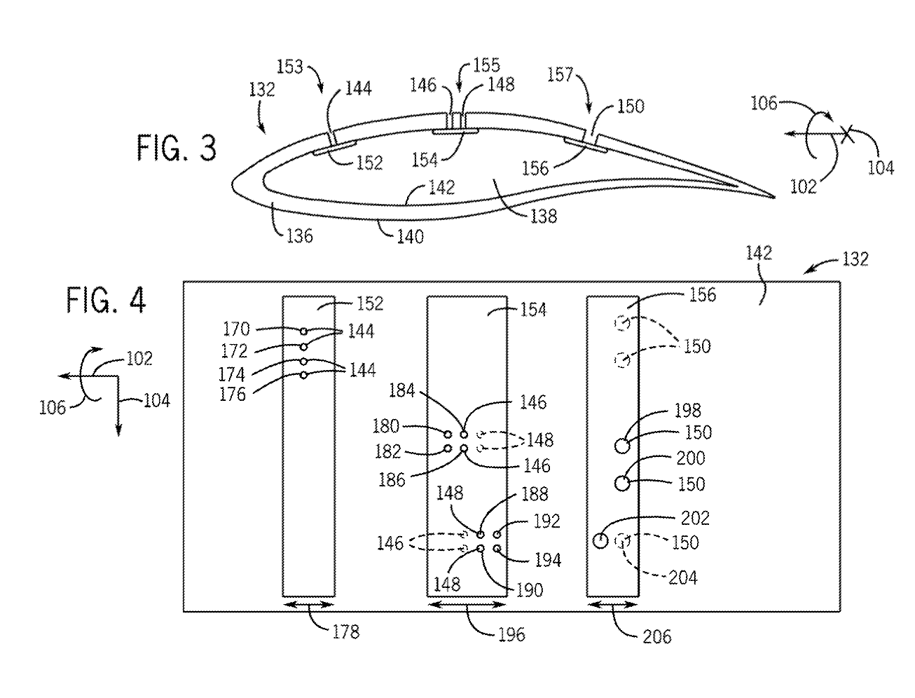

FIG. 3 is a cross-sectional view of an embodiment of the strut 132 of FIG. 2 with moveable plates that can be used to decrease flow separation. The strut 132 is illustrated as having a generally elongated tear drop shape. Such a configuration may minimize flow disturbances that the strut 132 causes to the exhaust flowing through the diffuser section 128 when the turbine engine 100 is operating under full load conditions. An exterior portion 136 of the strut 132 forms the visible tear drop shape while an interior portion 138 is hollow. Further, the exterior portion 136 has an outer surface 140 and an inner surface 142. Openings 144, 146, 148, and 150 extend from the outer surface 140 to the inner surface 142 and permit fluid (e.g., exhaust, air, etc) to flow through the openings 144, 146, 148, and 150, between the interior portion 138 and the exterior portion 136 of the strut 132 (e.g., fluid to flow from the interior portion 138, through the openings 144, 146, 148, and 150, to exit the strut 132). As may be appreciated, the openings 144, 146, 148, and 150 may each include multiple openings at various locations along the surface of the strut 132. During operation, a fluid may be injected into the interior portion 138 of the strut 132 (e.g., using a pump). The injected fluid may exit the strut 132 through openings 144, 146, 148, and 150 and may alter the flow of the exhaust flowing around the strut 132. For example, it may be desirable to allow fluid to flow through openings 144 during startup of the turbine engine 100 to improve the profile of exhaust flowing around the strut 132. Conversely, it may be desirable to inhibit fluid flow through any of the openings 144, 146, 148, and 150 when the turbine engine 100 is operating at full capacity. As may be appreciated, depending on the operational state of the turbine engine 100, disturbances to the exhaust flow caused by the strut 132 may be decreased when fluid is injected into the strut 132 and the injected fluid flows through at least one of the openings 144, 146, 148, and 150. For example, injected fluid may stop flow separation from occurring at various locations on the strut 132 depending on the operational state of the turbine engine 100 and whether fluid flow through the openings 144, 146, 148, and 150 is blocked or enabled.

A first moveable plate 152 is disposed in a first strut region 153. The first moveable plate 152 is coupled to the strut 132 and may be moved to increase or decrease fluid flow through the openings 144. Further, a second moveable plate 154 is disposed in a second strut region 155. The second moveable plate 154 is coupled to the strut 132 and may be moved to increase or decrease fluid flow through the openings 146 and 148. In addition, a third moveable plate 156 is disposed in a third strut region 157. The third moveable plate 156 is coupled to the strut 132 and may be moved to increase or decrease fluid flow through the openings 150. Thus, based on the position of the moveable plates 152, 154, and 156, the moveable plates may control the amount of fluid flowing through respective openings 144, 146, 148, and 150. As illustrated, the moveable plates 152, 154, and 156 are coupled to the inner surface 142 of the strut 132. However, in certain embodiments, the moveable plates 152, 154, and 156 may be coupled to the outer surface 140 of the strut 132 (i.e., on the outside of the strut 132).

The moveable plates 152, 154, and 156 may be constructed of any material, such as a metal, polymer, and so forth. In certain embodiments, the moveable plates 152, 154, and 156 may be constructed of a shape memory alloy. For example, the moveable plates 152, 154, and 156 may be constructed of a shape memory alloy formed using one or more of the following: copper, zinc, aluminum, nickel, titanium, gold, and iron. The shape memory alloy may be used to control the amount of fluid that flows through the openings 144, 146, 148, and 150 based on a temperature or some other characteristic of the alloy. For example, the shape memory alloy may thermally expand or contract based on the temperature of the strut 132 and/or the exhaust flowing through the gas turbine exhaust diffuser 128. As such, the shape memory alloy changes shape during operation to control the amount of fluid flow. It should be noted that in certain embodiments, the openings 144, 146, 148, and 150 may be arranged in one or more of the axial direction 102 (as shown), the radial direction 104, and/or the circumferential direction 106 to allow fluid to flow from the interior portion 138 of the strut 132 to the exterior portion 140.

FIG. 4 is a cross-sectional side view of one embodiment of the strut 132 with moveable plates, as illustrated in FIG. 3. The inner surface 142 is shown with the plates 152, 154, and 156 coupled to it. The first moveable plate 152 has openings 170, 172, 174, and 176. As illustrated, the openings 170, 172, 174, and 176 in the plate 152 are aligned with openings 144 in the strut 132. Thus, with the first moveable plate 152 in its illustrated position, fluid may flow through the strut exterior 136. Further, the plate 152 may be moved in the axial direction 102 as shown by arrow 178. As may be appreciated, a small amount of movement of the plate 152 may partially block the openings 144, while a larger amount of movement of the plate 152 may completely block the openings 144. Further, the plate 152 may be moved to either side (axially) to block the openings 144. Thus, the plate 152 may be moved between various positions to control the amount of fluid flowing through the openings 144. Specifically, the plate 152 may be positioned as illustrated so the openings 144 are completely open, the plate 152 may be positioned so the openings 144 are completely closed, or the plate 152 may be positioned at any location in between so the openings 144 are partially open.

The second moveable plate 154 has openings 180, 182, 184, 186, 188, 190, 192, and 194. Some of the openings 180, 182, 192, and 194 do not align with the openings 146 and 148 in the strut 132. Conversely, other openings 184, 186, 188, and 190 do align with the openings 146 and 148 in the strut 132. Some openings 146 and 148 in the strut 132 are illustrated with dashed lines because they do not align with an opening in the plate 154 as the plate 154 is currently positioned. However, when the plate 154 is moved in the axial direction 102 as shown by arrow 196, the openings 180, 182, 184, 186, 188, 190, 192, and 194 of the plate 154 may move to align with the currently unaligned openings 146 and 148. For example, the plate 154 may move to the right and the openings 184 and 186 of the plate 154 may align with the openings 148 in the strut 132, while the openings 180 and 182 of the plate 154 may align with the openings 146 in the strut 132. Further, the plate 154 may move to the left and the openings 188 and 190 of the plate 154 may align with the openings 146 in the strut 132, while the openings 192 and 194 of the plate 154 may align with the openings 148 in the strut 132.

The third moveable plate 156 has openings 198, 200, 202, and 204. One opening 202 does not align with the openings 150 in the strut 132, while the other openings 198, 200, and 204 do align with the openings 150 in the strut 132. Like the other plates 152 and 154, the plate 156 may be moved in the axial direction 102 as shown by arrow 206. Moving the plate 156 may cause the opening 202 of the plate 156 to move to align with one of the openings 150 and may cause the openings 198, 200, and 204 to move to not be aligned with one of the openings 150. Further, two of the openings 150 at the top of the plate 156 may not be aligned with any opening in the plate 156, even if the plate is moved in the axial direction 102. It should be noted that in certain embodiments, the plates 152, 154, and 156 may move in the radial direction 104 and/or the circumferential direction 106 to control fluid flow through the openings 144, 146, 148, and 150.

The openings 144, 146, 148, and 150 may have a diameter of any suitable size. For example, the diameter of the openings 144, 146, 148, and 150 may be approximately 5, 10, 15, 20, 25, 30, 40, or 50 mm. In certain embodiments, the openings 144, 146, 148, and 150 may have a diameter of approximately 6 to 30 mm, 22 to 60 mm, or 12 to 45 mm. Further, the openings 144, 146, 148, and 150 may be circular, oval, square, rectangular, triangular, or any other suitable shape. As may be appreciated, the openings in the plates 152, 154, and 156 may also be any suitable size or shape. Further, the openings in the plates 152, 154, and 156 may not be the same shapes as the openings 144, 146, 148, and 150. For example, the openings 144, 146, 148, and 150 may be circular and the openings in the plates 152, 154, and 156 may vary between different parts of a circle, such as a half-circle, crescent shape, pie shape, etc. As may be appreciated, the openings in the plates 152, 154, and 156 may be the same shapes and/or sizes as the openings 144, 146, 148, and 150. Further, the arrangement of the openings in each of the plates 152, 154, and 156 may be different on each plate, as illustrated, or the openings on each plate may be uniform. Specifically, the arrangement illustrated in FIG. 4 is meant to demonstrate that the openings may be in any suitable position based on the particular application. For example, the arrangement of the openings (e.g., pattern and location of the openings), number of the openings, size of the openings, and shape of the openings may be determined based on the operational requirements for a particular turbine engine 100.

It should be noted that by moving the plates 152, 154, and 156, the fluid flowing from the strut interior 138 through the openings 144, 146, 148, and 150 may be altered. In various situations, it may be desirable to allow fluid to flow through all, some, or none of the openings 144, 146, 148, and 150 in order to stop flow separation from occurring. For example, when the turbine engine 100 is operating at approximately full load capacity (e.g., approximately 100 percent capacity), it may be desirable to block fluid from flowing through all of the openings 144, 146, 148, and 150 so that the flow of exhaust around the struts 132 is not disturbed (e.g., the struts 132 may be designed for minimal flow separation when operating at full load capacity). Further, when the turbine engine 100 is operating at approximately 40 to 100 percent load capacity, it may be desirable to allow fluid to flow through openings 150 to alter the exhaust flow around the struts 132 and stop flow separation that may occur in the third strut region 157 without the fluid flowing through openings 150.

In addition, when the turbine engine 100 is operating at approximately 20 to 50 percent load capacity, it may be desirable to allow fluid to flow through two of the openings, for example, openings 146 and/or 148, to inhibit flow separation from occurring in the second strut region 155. Further, when the turbine engine 100 is operating at approximately 0 to 30 percent load capacity, it may be desirable to allow fluid to flow through opening 144 to inhibit flow separation from occurring in the first strut region 153. Further it may be desirable to allow fluid to flow through openings 144 during startup of the turbine engine 100. As may be appreciated, the specifics of which openings 144, 146, 148, and 150 will provide desired fluid flow through the exhaust diffuser section 128 may vary between systems and may depend on the particular application.

The plates 152, 154, and 156 may be moved in any manner to control the fluid flow through the openings 144, 146, 148, and 150 in the strut 132. For example, the plates 152, 154, and 156 may be moved by an actuation system to control the fluid flow. The actuation system may include hydraulically, pneumatically, mechanically, or electrically operated actuators. Further, the plates 152, 154, and 156 may be moved to control fluid flow based on a schedule, operational parameters, sensor measurements, and so forth. For example, the plates 152, 154, and 156 may be moved to allow or inhibit fluid flow based on a timed schedule where during specific time periods of operation, fluid may flow through specific openings 144, 146, 148, and 150. The timed periods may be correlated to the turbine engine 100 starting, stopping, or operating for a specific period of time. In addition, the plates 152, 154, and 156 may be configured to move based on an operational parameter of the turbine engine 100, such as the operating load capacity as previously described. Further, the plates 152, 154, and 156 may be configured to move based on sensor measurements, such as temperature sensors, flow sensors, operational state sensors, pressure sensors, etc.

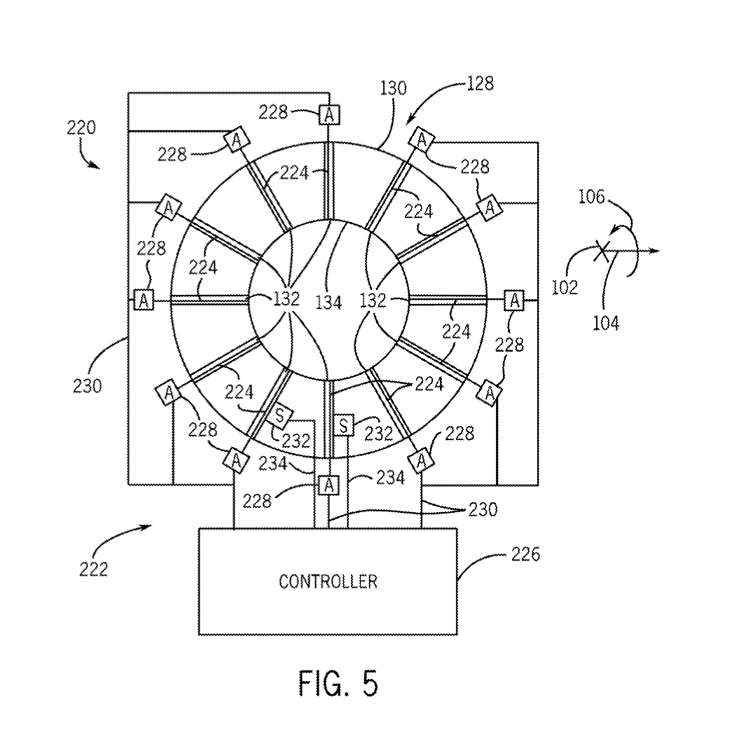

FIG. 5 is a block diagram of a gas turbine exhaust diffuser system 220 having a control system 222 for use in conjunction with moveable plates 224. As may be appreciated, the moveable plates 224 in each strut may include any number of plates that are used to control fluid flow through the struts 132. Further, the moveable plates 224 may each have a lever or some other attachment that couples the plates 224 to a device for moving the plates 224. The control system 222 includes a controller 226 that may be configured to send (or transmit) control signals to actuators 228. The control signals may cause the actuators 228 to move the plates 224 to desired positions and, thus, alter the fluid flow through the struts 132. In certain embodiments, the controller 226 may be a computer, an expansion card for a computer, a stand-alone computing device, a microprocessor, an integrated circuit (e.g., programmable logic controller (PLC)), and so forth. As previously discussed, the actuators 228 may be any type of actuator, such as a hydraulic, pneumatic, mechanical (e.g., rack and pinion), or electrical actuator. The control system 222 includes actuator wiring 228 for transmitting control signals to the actuators 228. However, as may be appreciated, certain embodiments may not include actuator wiring and instead may include hydraulic and/or pneumatic circuitry for controlling the actuators 228.

The controller 226 may also be configured to receive signals from sensors 232 that provide an indication of a sensed parameter. For example, the sensors 232 may provide an indication of an operational state of the turbine engine 100, a temperature, an amount of fluid flow, and/or a fluid pressure. Further, the sensors 232 may provide any measurement that can be used by the controller 226 to determine when to move the plates 224. The sensors 232 are communicatively coupled to the controller 226 using wires 234. As illustrated, the sensors 232 may be coupled directly to the struts 132, or in other embodiments, the sensors 232 may be placed in any suitable location. For example, the sensors 232 may be located at the front edge of the struts 132 (e.g., the location that first contacts the exhaust flow), back edge of the struts 132 (e.g., the location that has final contact with the exhaust flow), within the struts 132 to be flush with the struts 132 (e.g., to cause minimal disturbance to the exhaust flow), in or on the outer wall 130, and/or in or on the hub 134.

As may be appreciated, the techniques described herein may enable the use of strut fluidics in the exhaust diffuser system 220. Specifically, fluid flow separation may be decreased by moving plates to cover or open holes in the struts. Therefore, the turbine engine 100 may have performance gains during part load operation. Further, the operation of the turbine engine 100 during full load operation may be impacted minimally, if at all, by using such techniques.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gas turbine exhaust comprising:
a strut of the gas turbine exhaust having a first opening configured to permit a fluid to flow between an interior portion of the strut and an exterior portion of the strut; and
a moveable plate coupled to the strut and configured to control an amount of the fluid flowing through the first opening.

2. The gas turbine exhaust of claim 1, wherein the movable plate is coupled to an inner surface of the strut.

3. The gas turbine exhaust of claim 1, wherein the movable plate is coupled to an outer surface of the strut.

4. The gas turbine exhaust of claim 1, wherein the moveable plate comprises a shape memory alloy.

5. The gas turbine exhaust of claim 1, wherein the movable plate is configured to be moved between at least two positions to control the amount of the fluid flowing through the first opening.

6. The gas turbine exhaust of claim 5, wherein the moveable plate is configured to be moved between the at least two positions based on a received signal.

7. The gas turbine exhaust of claim 6, wherein the moveable plate is configured to be moved to a first position to inhibit fluid flow through the first opening when a gas turbine is at full load operation and configured to be moved to a second position to allow fluid flow through the first opening during the gas turbine startup.

8. The gas turbine exhaust of claim 1, comprising a second movable plate configured to alter fluid flow through a second opening in the strut during a gas turbine startup, wherein the second opening is in a first strut region.

9. The gas turbine exhaust of claim 8, comprising a third movable plate configured to alter fluid flow through a third opening in the strut during operation of a gas turbine, wherein the third opening is in a second strut region and the third movable plate is configured to be moved when the gas turbine is operating between approximately 20 and 50 percent load capacity.

10. The gas turbine exhaust of claim 9, wherein the first opening is in a third strut region and the movable plate is configured to be moved when the gas turbine is operating between approximately 40 and 100 percent load capacity.

11. A control system to a gas turbine exhaust diffuser comprising:
a controller configured to:
receive a signal indicating an operational state of a gas turbine engine; and
transmit a control signal to an actuator, wherein the control signal causes the actuator to move a plate coupled to a strut located in the gas turbine exhaust diffuser to alter fluid flow through the strut.

12. The control system of claim 11, comprising a sensor configured to produce the signal indicating the operational state of the gas turbine engine.

13. The control system of claim 12, wherein the sensor is a temperature sensor.

14. The control system of claim 11, wherein the actuator comprises a hydraulic actuator.

15. The control system of claim 11, wherein the actuator comprises a pneumatic actuator.

16. A gas turbine exhaust diffuser comprising:
an inner wall forming a hub;
an outer wall encompassing the inner wall;
a plurality of struts coupled between the inner wall and the outer wall of the gas turbine exhaust diffuser, wherein each strut comprises at least one opening and a movable plate configured to control fluid flow through the at least one opening.

17. The diffuser of claim 16, wherein the movable plate is configured to be moved between at least two positions to control fluid flow through the at least one opening.

18. The diffuser of claim 16, wherein the movable plate is configured to control fluid flow based on a schedule.

19. The diffuser of claim 16, wherein the movable plate is configured to control fluid flow based on operational parameters.

20. The diffuser of claim 16, wherein the movable plate is configured to control fluid flow based on sensor measurements.
